(19) United States
(12) Patent Application Publication
(10) Pub. No.: US 2004/0080650 A1
(43) Pub. Date: Apr. 29, 2004

(54) CMOS image sensor single chip integrated with a RF transmitter

(76) Inventors: Jyn-Guo Hwang, Hsinchu City (TW); Kuan-Ching Chang, Hsinchu City (TW)

Correspondence Address: BIRCH STEWART KOLASCH & BIRCH, PO BOX 747, FALLS CHURCH, VA, 22040-0747, US

(21) Appl. No.: 10/687,877

(22) Filed: Oct. 20, 2003

(30) Foreign Application Priority Data
Oct. 21, 2002 (TW) 091216830

(51) Int. Cl. H04N 3/14

(52) U.S. Cl. 348/308

(57) ABSTRACT

The present invention discloses a CMOS image sensor single chip integrated with a RF transmitter utilizing CMOS technology. The invention integrates CMOS image sensor and RF transmitter in a single chip, which can transmit an image detected by the CMOS image sensor directly through the RF transmitter.

### FIELD OF THE INVENTION

The present invention generally relates to a CMOS image sensor single chip, and more particularly to a CMOS image sensor single chip integrated with RF transmitter.

### BACKGROUND OF THE INVENTION

Currently, due to the serious short supply causing by huge market requirements of image sensor, the image sensor market which the CCDs (charge coupling devices) give the first place in past has gradually been invaded by the CMOS (Complementary Metal Oxide Semiconductor) image sensor. In the future, CMOS image sensors are expected to surpass CCDs in quantity, because of the integration with the CMOS manufacturing process. The advantage of integration of CMOS manufacturing process in high degree makes the CMOS image sensors can integrate with other devices in a single chip.

CMOS image sensor, is mainly constructed with CMOS sensing array, readout circuit, pre-amplify unit and analog to digital converter (ADC). Due to use of the CMOS process, these devices can be fabricated in a single chip in general.

However, the current CMOS image sensors are mainly used for the image capturing for digital cameras and the action identification. In general, the CMOS image sensors having more pixels are for the market of the digital camera, while the CMOS image sensors having fewer pixels are for the market of action identification. Nevertheless, even though the CMOS image sensors have the possibility to integrate with other devices, there are still no related products of such system on a chip. Therefore, there is much developing space in the design of the CMOS image sensor in the future.

### SUMMARY OF THE INVENTION

It is a primary object of the present invention to provide a CMOS image sensor single chip integrated with the RF transmitter, which can transmit an image detected by the CMOS image sensor directly through the RF transmitter.

According to the present invention, the CMOS image sensor single chip integrated with the RF transmitter comprises: a CMOS image sensor and a RF transmitter.

In which, the CMOS image sensor receives the input light and transfers the light signal to the voltage signal, and further transfers the voltage signal to the image signal through the read-out in the circuit of the sensor. The RF transmitter receives the image signal, and modulates the image signal into the RF signal transmitted through the antenna.

The CMOS image sensor comprises an image sensing array, a readout circuit and a timing control circuit. The image sensing array is used for transferring the received input light to the sensing voltage. Then, the readout circuit comprising the column-readout circuit and the row-readout circuit reads the sensing voltage and outputs to be the image signal. The timing control circuit controls the timing of the exposure in the image sensing array and the readout in the readout circuit (the column-readout circuit and the row-readout circuit).

CMOS image sensor further comprises an ADC, used for transfers the image signal to the digital image signal.

Additionally, the linear CMOS image sensor can be utilized. According to the present invention, a CMOS image sensor single chip integrated with RF transmitter is disclosed, comprising: a CMOS image sensor, a signal processing unit and a RF transmitter. In which, the signal processing unit is used for further processing of the digital image signal transmitted from the CMOS image sensor and then transmitting away through the RF transmitter.

Other objects, advantages, and novel features of the invention will become more apparent from the following detailed description when taken in conjunction with the accompanying drawing.

### BRIEF DESCRIPTION OF THE DRAWINGS

FIG. 1 illustrates the functional blocks of the CMOS image sensor single chip integrated with the RF transmitter of the invention; and

FIG. 2 illustrates the functional blocks of second embodiment of the CMOS image sensor single chip integrated with the RF transmitter of the invention.

### DETAILED DESCRIPTION OF THE PREFERRED EMBODIMENT

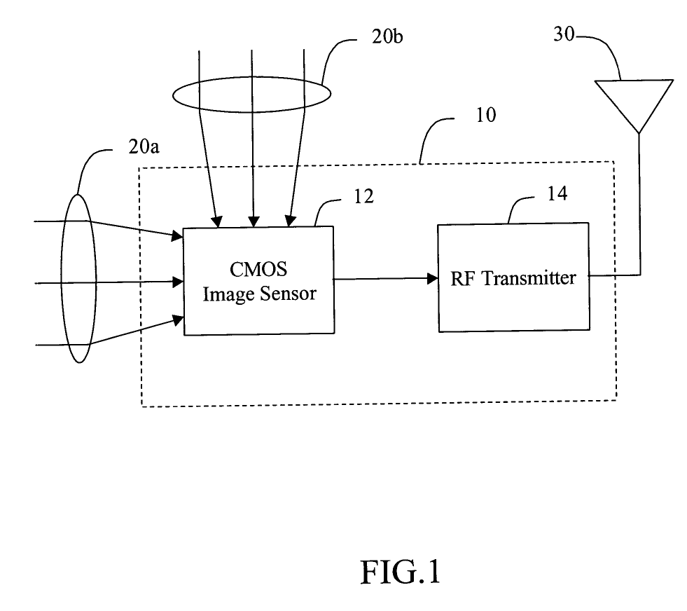

Please refer to FIG. 1, showing the first embodiment of the present invention. The CMOS image sensor single chip integrated with the RF transmitter 10 is formed of two main parts, including: the CMOS image sensor 12 and the RF transmitter 14. The CMOS image sensor 12 is used for detecting the input light from outside part. Namely, the incoming light transmitted from the lens 20a and 20b. After detecting the input light, the CMOS image sensor 12 transfers the input light to sensing voltage, which is transferred to the image signal through the circuit among the sensor. The RF transmitter 14 receives the image signal and then modulates the image signal to transmit by the antenna 30.

CMOS image sensor 12 can use two types: the image sensing array and linear image sensor, both can be designed as different applications. The image sensing array can be used for image access of more pixels or action identification of fewer pixels, while the linear image sensor can be used for various usages such as barcode reader. No matter what kind of image sensor can use the single chip framework of the present invention. The following will describe individually:

Firstly, Image Sensing Array:

As the image sensor is one illustrated in FIG. 1, the framework can be: an image sensing array, a readout circuit and a timing control circuit. The image sensing array is used for transferring the detected input light to the sensing voltage. Then, the readout circuit comprising the column-readout circuit and the row-readout circuit reads the sensing voltage and outputs the sensing voltage as image signal. In which, the timing of the exposure in the image sensing array and the timing of the readout in the readout circuit (the column-readout circuit and the row-readout circuit) are controlled by the timing control circuit.

In addition, the voltage values sensed by the image sensing array are so small that they are not easily read. Therefore, the readout circuit usually comprises the pre-amplify unit, used for amplifying the sensing voltage in readable range. The final image signals are usually amplified by the pre-amplify unit.

The above mentioned image signal is analog image signal. In fact, the analog image signal, seen as sampled analog signal, can be transmitted to the RF transmitter to be modulated and then transmitted out. There are many modulating methods for the analog signal, such as the amplitude modulation, angular modulation and code modulation.

On application, the analog image signal can be displayed directly as the image information in the analog display system such as CRT display or LCD display etc., after the analog image signal is directly transmitted through the RF transmitter 14. The above application can at least use in the toys or systems requiring lower resolution. Another, the analog image signal can also be processed through the ADC to display in digital display system (for example, computer) after modulating the analog image signal. Therefore, the invention can be used for transmitting the simple image through the RF transmitting apparatus and making the whole system framework simple and cost lower. There are other expansible applications, for example, wireless optical mouse, which can transmit the accessed image directly to the computer and then compare the image by the software to transfer to the displacement and the velocity value of the mouse.

In addition, the above mentioned analog signal can transfer to the digital signal first to further modulate. Namely, the CMOS image sensor 12 further has an analog to digital converter (ADC). Accordingly, the image signal that is read from the above mentioned readout circuit can be transferred to the digital image signal and transmitted out through the RF transmitter. The digital image signal hereby is the above mentioned image signal. The advantages of transferring to the digital image signal are getting better noise-avoiding ability by further coding and omitting additional image ADC when the receiver is the digital system.

Secondly, Linear Image Sensor:

The difference comparing to the image sensing array is that the linear image sensor can only sense the image signal of one dimension. The main application of linear image sensor is the barcode-reading. Current barcode technology has been relatively popular and has relatively expansive applications since the most business products have the barcodes.

The linear CMOS image sensor is composed: a linear image sensor, a readout circuit and a timing control circuit. Similarly, the output of the linear CMOS image sensor is analog image signal. If the output of the linear CMOS image sensor is digital image signal, the CMOS image sensor must add with the ADC as mentioned in the first embodiment. Others are the same as the above mentioned image sensing array and will not mentioned again. The framework applied linear form can be used for the application of the wireless barcode reader.

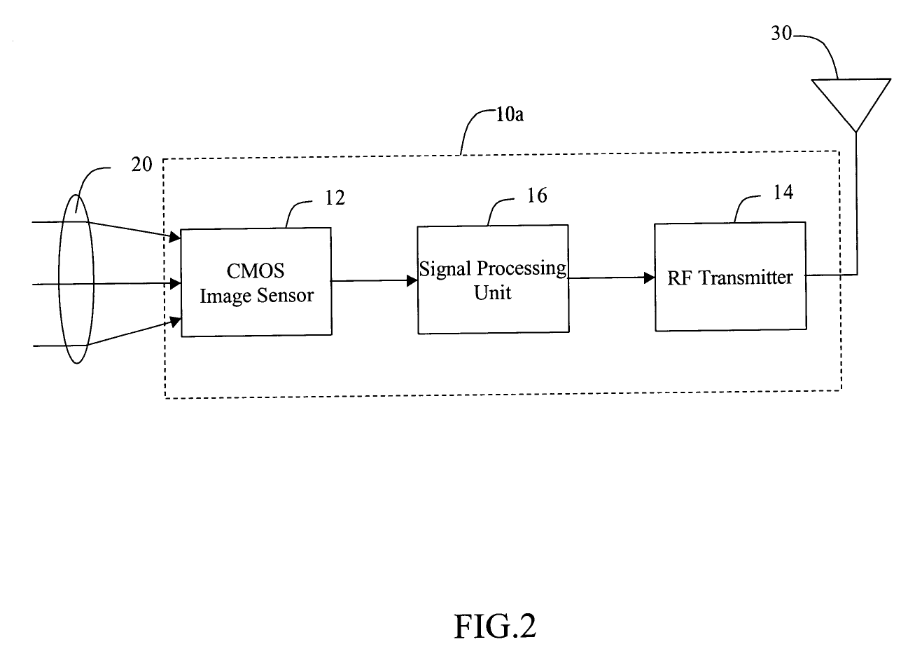

Moreover, the framework of expanding the present invention can be the CMOS image sensor single chip integrated with the RF transmitter 10a, which adds a signal processing unit 16 between the CMOS image sensor 12 and the RF transmitter 14, as shown in FIG. 2. The goal of adding the signal processing unit 16 is to let the original image signal further image processing for special application. It means that the signal processing unit 16 further processes the image signal processed by the CMOS image sensor 12 to application signal and then to be transmitted out by the RF transmitter 14. However, after adding with the signal processing unit 16, the CMOS image sensor 12 must output the digital image signal instead of the analog image signal. In other words, the CMOS image sensor 12 must comprise the ADC part. The mentioned timing control circuit can be integrated into the signal processing unit 16. Namely, the signal processing unit 16 can provide the basic timing and control the whole sequences of the exposure and the readout of the image signal. Following will disclose some practical application examples of the signal processing unit.

Application 1: The signal processing unit 16 can be designed as a compression part to compress the image accessed by the CMOS image sensor to reduce the information capacity and to achieve the debug aim in the compressing process. Therefore, the transferring process of the image signal can reduce the bandwidth requirement of the RF transmitter.

Application 2: The signal processing unit 16 can be designed as an action identifying part, for example, the action identification of the mouse. The application example can be the design of the wireless optical mouse. The signal processing unit 16 compares continuous two frames outputted from the CMOS image sensor 12, and then calculates the information of the displacement and velocity to further obtain the action information. Therefore, the processed signal will be transmitted out through the RF transmitter instead of the image signal. At the time, the required wireless bandwidth will be smaller.

Application 3: The signal processing unit 16 can be designed as an information transforming part. For example, on the condition of the CMOS image sensor 12 being the linear image sensor, the signal processing unit 16 can directly identify the scanning barcode and transfer the scanning barcode to the numerical information. Therefore, the information capacity transmitted by the RF transmitter 14 will be relatively small and then the bandwidth of the RF transmitter will be reduced as well as cost down.

The above mentioned applications having the same architecture as first embodiment basically, no matter what kind of the image sensor (array or linear) is used. However, due to usage of the signal processing unit 16, the timing control circuit of the CMOS image sensor 12 can be integrated into the design of the signal processing unit 16 or into the CMOS image sensor 12 itself.

Although the invention has been explained in relation to its preferred embodiment, it is not used to limit the invention. It is to be understood that many other possible modifications and variations can be made by those skilled in the art without departing from the spirit and scope of the invention as hereinafter claimed.

The present invention has been described using exemplary preferred embodiment. However, it is to be understood that the scope of the invention is not limited to the disclosed embodiments. On the contrary, it is intended to cover various modifications and similar specifications. The scope of the claims should be interpreted to involve all such modifications and specifications.

What is claimed is:

1. A CMOS image sensor single chip integrated with a RF transmitter, comprising:
a complementary metal oxide semiconductor (CMOS) image sensor, used for detecting an input light as image signal; and
a RF transmitter, used for modulating said image signal to RF signal to be transmitted.

2. The CMOS image sensor single chip integrated with a RF transmitter of claim 1, wherein said CMOS sensor comprises:
an image sensing array, used for receiving said input light and transferring said input light to sensing voltage;
a readout circuit, used for reading said sensing voltage and outputting said sensing voltage as said image signal; and
a timing control circuit, used for controlling working timing of said image sensing array and said readout circuit.

3. The CMOS image sensor single chip integrated with a RF transmitter of claim 1, wherein said readout circuit is formed of a column-readout circuit and a row-readout circuit.

4. The CMOS image sensor single chip integrated with a RF transmitter of claim 2, wherein said readout circuit further comprising a pre-amplify unit, used for amplifying said sensing voltage as said image signal.

5. The CMOS image sensor single chip integrated with a RF transmitter of claim 1, wherein said CMOS image sensor comprises:
an image sensing array, used for receiving said input light and transferring said input light to a sensing voltage;
a readout circuit, used for reading said sensing voltage and outputting said sensing voltage as a analog image signal;
a timing control circuit, used for controlling working timing of said image sensing array and said readout circuit; and
an analog to digital converter, used for receiving said analog image signal and transferring said analog image signal to said image signal.

6. The CMOS image sensor single chip integrated with a RF transmitter of claim 5, wherein is formed of a column-readout circuit and a row-readout circuit.

7. The CMOS image sensor single chip integrated with a RF transmitter of claim 5, wherein said readout circuit further comprising a pre-amplify unit, used for amplifying said sensing voltage as said analog image signal.

8. The CMOS image sensor single chip integrated with a RF transmitter of claim 1, wherein said CMOS image sensor comprises:
a linear image sensor, used for receiving said input light and transferring said input light to sensing voltage;
a readout circuit, used for reading said sensing voltage and outputting said sensing voltage as said image signal; and
a timing control circuit, used for controlling working timing of said linear image sensor and said readout circuit.

9. The CMOS image sensor single chip integrated with a RF transmitter of claim 8, wherein said readout circuit further comprises a pre-amplify unit, used for amplifying said sensing voltage as said image signal.

10. The CMOS image sensor single chip integrated with a RF transmitter of claim 1, said CMOS image sensor comprises:
a linear image sensor, used for receiving said input light and transferring said input light to sensing voltage;
a readout circuit, used for reading said sensing voltage and outputting said sensing voltage as analog image signal;
a timing control circuit, used for controlling working timing of said linear image sensor and said readout circuit; and
an analog to digital converter, used for receiving said analog image signal and transferring said analog image signal as said image signal.

11. The CMOS image sensor single chip integrated with a RF transmitter of claim 10, said readout circuit further comprises a pre-amplify unit, used for amplifying said sensing voltage as said analog image signal.

12. A CMOS image sensor single chip integrated with a RF transmitter, comprising:
a complementary metal oxide semiconductor (CMOS) image sensor, used for detecting an input light as digital image signal;
a signal processing unit, used for processing of said digital image signal and transferring said digital image signal to application signal; and
a RF transmitter, used for modulating said application signal to RF signal to be transmitted.

13. The CMOS image sensor single chip integrated with a RF transmitter of claim 12, wherein said CMOS image sensor comprises:
an image sensing array, used for receiving said input light and transferring said input light to sensing voltage;
a readout circuit, used for reading said sensing voltage and outputting said sensing voltage as analog image signal;
a timing control circuit, used for controllin working timing of said image sensing array and said readout circuit; and
an analog to digital converter, used for receiving said analog image signal and transferring said analog image signal as said digital image signal.

14. The CMOS image sensor single chip integrated with a RF transmitter of claim 12, said CMOS image sensor comprises:
a linear image sensor, used for receiving said input light and transferring said input light to sensing voltage;
a readout circuit, used for reading said sensing voltage and outputting said sensing voltage as analog image signal;
a timing control circuit, used for controlling working timing of said linear image sensor and said readout circuit; and
an analog to digital converter, used for receiving said analog image signal and transferring said analog image signal as said digital image signal.

15. A CMOS image sensor single chip integrated with a RF transmitter, comprising:
a complementary metal oxide semiconductor (CMOS) image sensor, used for detecting an input light as digital image signal;
a signal processing unit, used for providing a basic timing to be working timing of said CMOS sensor, receiving said digital image signal to do basic processing, and transferring said digital image signal to application signal; and
a RF transmitter, used for modulating said applicaiton signal to RF signal to be transmitted.

16. The CMOS image sensor single chip integrated with a RF transmitter of claim 15, said CMOS image sensor comprises:
an image sensing array, used for receiving said input light and transferring said input light to a sensing voltage;
a readout circuit, used for reading said sensing voltage and outputting said sensing voltage as a analog image signal; and
an analog to digital converter, used for receiving said analog image signal and transferring said analog image signal as said image signal.

17. The CMOS image sensor single chip integrated with a RF transmitter of claim 15, said CMOS image sensor comprises:
a linear image sensor, used for receiving said input light and transferring said input light to a sensing voltage;
a readout circuit, used for reading said sensing voltage and outputting said sensing voltage as a analog image signal; and
an analog to digital converter, used for receiving said analog image signal and transferring said analog image signal as said image signal.

18. The CMOS image sensor single chip integrated with a RF transmitter of claim 15, wherein said digital processing unit can further compress said digital image signal and transfer said digital image signal to a application signal.
